(19) United States
(12) Patent Application Publication
(10) Pub. No.: US 2020/0063880 A1
(43) Pub. Date: Feb. 27, 2020

(54) TAMPER RESISTANT IN LINE ADJUSTABLE VALVE FOR PREVENTING AIR FROM BEING DIRECTED TO A WATER METER

(71) Applicant: WATER PILOT LLC, Aventura, FL (US)

(72) Inventor: Clarence L. Pyritz, JR., Daphne, AL (US)

(21) Appl. No.: 16/112,653

(22) Filed: Aug. 25, 2018

(51) Int. Cl. F16K 24/02; F16K 1/42; F16K 1/52; F16K 15/06

(52) U.S. Cl. CPC F16K 24/02; F16K 15/063; F16K 1/523; F16K 1/422

(57) ABSTRACT

A valve for a water line for preventing or reducing air from being read by a water meter or other device as water. The preferred form of the valve is in line adjustable, i.e., without removing the valve from the water line and/or without shutting-off the flow of water through the water line to vary the force necessary to open the valve to allow a fluid to flow therethrough. Preferably, the valve includes a simple user manipulated tool to vary the force necessary to open the valve from a maximum force to a minimum force without detaching the user manipulated tool from the valve. The force adjusting features disposed in the valve housing are designed to maximize fluid flow through the valve housing while still allowing inline adjustment of the valve. Preferably, the valve includes an anti-tampering member that prevents an unauthorized user from altering the force necessary to open the valve.

### FIELD OF THE INVENTION

The present invention is directed to a valve for a fluid line configured to prevent or significantly reduce air from being directed to another element in the fluid line. In a preferred form, the valve is disposed in a water line and configured to prevent air from being read by a water meter or similar device as water. The preferred form of the valve is inline adjustable, i.e., the force/fluid pressure necessary to open the valve to allow a fluid to flow therethrough can be readily varied/adjusted without removing the valve from the water line and/or without shutting-off the flow of water through the water line. The preferred form of the valve includes a simple to operate user manipulated tool to vary the force necessary to open the valve between a maximum force and a minimum force and numerous intermediate forces (i.e., forces between a maximum force and a minimum force) without detaching the user manipulated tool from the valve. In the preferred form, the force adjusting features disposed in the valve housing are designed to maximize fluid flow through the valve housing while still allowing inline adjustment of the valve. In a preferred form, the valve includes an anti-tampering member that prevents an unauthorized user from altering the force/fluid pressure necessary to open the valve.

### BACKGROUND OF THE INVENTION

Water that is supplied to various building structures including hotels, office buildings, homes and other structures is read by a water meter and the water meter reading is used to bill the appropriate entity for water usage. Air is often mistakenly read by the water meter as water as the water meter cannot distinguish between air and water. This results in excessive billing which is obviously extremely undesirable. Air can erroneously be read as water where air is entrained, trapped and/or dissolved in water passing through the water meter. Air can enter the water line, for example, due to a rupture or crack in the water line. Many types of water meters also register entrained, trapped and dissolved air as water volume, which can lead to over-registration of consumption, in systems with intermittent supply pressure, where the water supply pressure surges and the incoming water pushes entrained, trapped and dissolved air through the water meter.

Valves have been introduced in an attempt to prevent air from being read as water by a water meter. These valves are purportedly designed to compresses air that is entrained, trapped and/or dissolved in water flowing through the water line to reduce or eliminate air from being read by the water meter as water. U.S. Patent Publication No. 2009/0289207 proposes a valve upstream of the water meter while U.S. Pat. No. 8,707,981 proposes a valve downstream of the water meter. Regardless of the location of the existing valves in the water line, the existing valves have significant inherent disadvantages. For example, several existing valves designed to prevent air from being read as water by a water meter have no means to allow for adjustment of the force necessary to open the valve to allow fluid to flow through the valve. Other such valves require the valve to be removed from the water line to adjust the force necessary to open the valve to allow fluid to flow through the valve. One valve on the market allows for inline adjustment but suffers from significant and inherent disadvantages. The valve is marketed under the name SMART VALVE. The force adjustment mechanism in the SMART VALVE is readily accessible to any one that wants to tamper with the valve. This is extremely undesirable as the setting of the valve can be readily varied by an unauthorized user which could result in air being read by a water meter if the force is set too low or the flow of water to the corresponding building structure being shut-off, reduced or otherwise inhibited if the force setting is set too high by the unauthorized user. Further, the SMART VALVE includes a force adjustment tool that must be repeatedly disconnected from the valve to adjust the force necessary to open the valve to allow fluid to flow through the valve from a minimum value to a maximum value and vice-a-versa.

### OBJECTS AND SUMMARY OF THE INVENTION

An object of the present invention is to provide a novel and unobvious valve.

Another object of a preferred embodiment of the present invention is to provide a valve in a fluid line that prevents or significantly reduces air flow to another element in the fluid line (e.g., a water meter).

Yet another object of a preferred embodiment of the present invention is to provide a valve in a water line for preventing air from being read by a water meter as water where the valve is inline adjustable, i.e., the valve is adjustable while the valve is connected to or disposed in the water line.

A further object of a preferred embodiment of the present invention is to provide an inline adjustable valve that includes a user manipulated adjustment tool configured to allow an individual to vary the force necessary to open the valve between a maximum force and a minimum force and numerous intermediate forces therebetween without detaching the user manipulated adjustment tool from the valve.

Still a further object of a preferred embodiment of the present invention is to provide an inline adjustable valve having a user manipulated adjustment tool configured to allow even an unskilled worker to readily and/or precisely vary the force necessary to open the valve.

Yet another object of a preferred embodiment of the present invention is to provide an inline adjustable valve that includes an anti-tempering member that prevents an unauthorized user from tampering with the valve.

Yet a further object of a preferred embodiment of the present invention is to provide an inline adjustable valve wherein the force adjustment features that are disposed in the valve housing are configured to maximize fluid flow through the valve housing.

Still a further object of a preferred embodiment of the present invention is to provide an inline adjustable valve wherein the force adjustment feature includes a shaft operably connected to a user manipulated tool in such a manner that the user manipulated tool can be readily disconnected from the shaft merely by moving the user manipulated tool away from the shaft.

Yet still a further object of a preferred embodiment of the present invention is to provide an inline adjustable valve wherein the force adjustment feature includes a shaft operably connected to a user manipulated tool wherein rotation of the user manipulated tool causes the shaft to move away from or towards the valve housing depending on the direction the tool is rotated to adjust the force necessary to cause the valve to allow fluid to flow through the valve housing.

Still another object of a preferred embodiment of the present invention is to provide an inline adjustable valve wherein the force adjustment feature includes a shaft having one terminal end connected to a cam and the other terminal end of the shaft is connected to a user manipulated tool wherein rotation of the user manipulated tool causes the cam to compress the spring or allow the spring to expand depending on the direction the tool is rotated to adjust the force necessary to cause the valve to allow fluid to flow through the valve housing.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one preferred embodiment of the present invention is directed to an apparatus for reducing airflow to one or more members in a water line. The apparatus includes a valve configured to be installed in the water line. The valve is configured to prevent or reduce air flow to one or more members in the water line. The valve includes a valve housing having first and second opposing ends. The first opposing end has a fluid inlet and the second opposing end has a fluid outlet. The valve further includes a valve member, a valve seat and a spring. The spring is configured to exert a biasing force on the valve member to cause the valve member to engage the valve seat to prevent fluid from flowing through the valve housing. A spring force adjustment member is operably connected to the valve. The spring force adjustment member is configured to permit a user to adjust the force of the spring without removing the valve from the water line. The spring force adjustment member has a user manipulated member connected to the valve. The user manipulated member when connected to the valve is configured to allow a user to adjust the force of the spring without detaching the user manipulated member from the valve in at least one of the following manners: (i) from a minimum spring force to a maximum spring force; and, (ii) from a maximum spring force to a minimum spring force.

Another preferred embodiment of the present invention is directed to an apparatus for reducing airflow to one or more members in a water line. The apparatus includes a valve configured to be installed in the water line. The valve is configured to prevent or reduce air flow to one or more members in the water line. The valve includes a valve housing having first and second opposing ends. The first opposing end has a fluid inlet and the second opposing end has a fluid outlet. The valve further includes a valve member, a valve seat and a biasing member being configured to exert a biasing force on the valve member to cause the valve member to engage the valve seat to prevent fluid from flowing through the valve housing. A biasing force adjustment member is operably connected to the valve. The biasing force adjustment member is configured to permit a user to adjust the force of the biasing member without removing the valve from the water line. The biasing force adjustment member includes an activation shaft and a first cam. The activation shaft is operably connected to the first cam. The activation shaft has a longitudinal axis. The activation shaft is configured to move in two opposing directions along the longitudinal axis of the activation shaft to cause corresponding movement of the first cam wherein the two opposing directions include a first direction which is away from the first cam and a second direction which is towards the first cam.

A further preferred embodiment of the present invention is directed to an apparatus for reducing airflow to one or more members in a water line. The apparatus includes a valve configured to be installed in the water line. The valve is configured to prevent or reduce air flow to one or more members in the water line. The valve includes a valve housing having first and second opposing ends. The first opposing end has a fluid inlet and the second opposing end has a fluid outlet. The valve further includes a valve member, a valve seat and a spring configured to exert a biasing force on the valve member to cause the valve member to engage the valve seat to prevent fluid from flowing through the valve housing. A spring force adjustment member is operably connected to the valve. The spring force adjustment member is configured to permit a user to adjust the force of the spring without removing the valve from the water line. An anti-tampering member is operably associated with the spring force adjustment member for preventing an unauthorized individual from accessing the spring force adjustment member to adjust the spring force of the spring.

The above preferred forms of the present invention described above provide various examples of preferred embodiments of the present invention and are not to be construed as limiting the present invention to any of the preferred forms described above.

### BRIEF DESCRIPTION OF THE DRAWINGS

FIG. 1 is a perspective view of a preferred form of the present invention with various elements (i.e., the valve housing and the lower housing of the adjustment member) being shown as being transparent solely for allowing other components of the preferred form of the invention to be readily visible.

FIG. 2 is an exploded perspective view of a preferred form of the present invention.

FIG. 3 is a perspective view of a preferred form of a spring support member.

FIG. 4 is an elevational view of the component depicted in FIG. 3.

FIG. 5 is a front elevational view of the component depicted in FIG. 3.

FIG. 6 is a top plan view of the component depicted in FIG. 3.

FIG. 7 is a perspective view of an anti-rotational member formed in accordance with a preferred embodiment of the present invention.

FIG. 8 is a top plan view of the component depicted in FIG. 7.

FIG. 9 is a front elevational view of the component depicted in FIG. 7.

FIG. 10 is a side elevational view of the component depicted in FIG. 7.

FIG. 11 is a perspective view of a cam member formed in accordance with a preferred embodiment of the present invention.

FIG. 12 is a top plan view of the component depicted in FIG. 11.

FIG. 13 is a side elevational view of the component depicted in FIG. 11.

FIG. 14 is a rear elevational view of the component depicted in FIG. 11.

FIG. 15 is a fragmentary perspective view of another preferred form of the present invention with various elements (i.e., the valve housing and the lower housing of the adjustment member) being shown as being transparent solely for allowing other components of the preferred form of the invention to be readily visible.

FIG. 16 is a fragmentary perspective view of the preferred form of the present invention depicted in FIG. 15 with various elements (i.e., the valve housing and the lower housing of the adjustment member) being shown as being transparent solely for allowing other components of this form of the invention to be readily visible.

FIG. 17 is a perspective view of an alternative form of the cam member to that depicted in FIG. 11.

FIG. 18 is a side elevational view of the component depicted in FIG. 17.

FIG. 19 is a top, plan view of the component depicted in FIG. 17.

FIG. 20 is a rear elevational view of the component depicted in FIG. 17.

FIG. 21 is a perspective view of an alternative form of a spring support member to that depicted in FIG. 3.

FIG. 22 is a front elevational view of the component depicted in FIG. 21.

FIG. 23 is a top, plan view of the component depicted in FIG. 21.

FIG. 24 is a side elevational view of the component depicted in FIG. 21.

FIG. 25 is a perspective view of an alternative form to activating/pressure shaft 21 depicted in, for example, FIG. 2.

FIG. 26 is a side elevational view of the component depicted in FIG. 25.

FIG. 27 is a top, plan view of the component depicted in FIG. 25.

### DETAILED DESCRIPTION OF THE PREFERRED EMBODIMENTS OF THE INVENTION

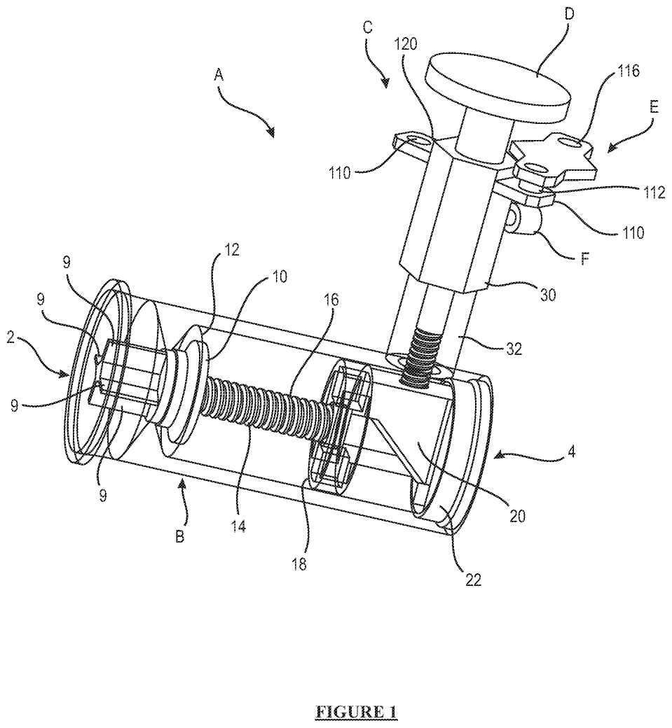

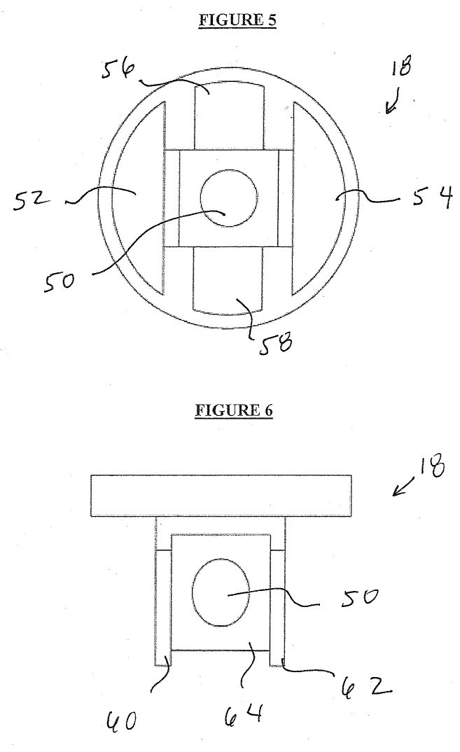

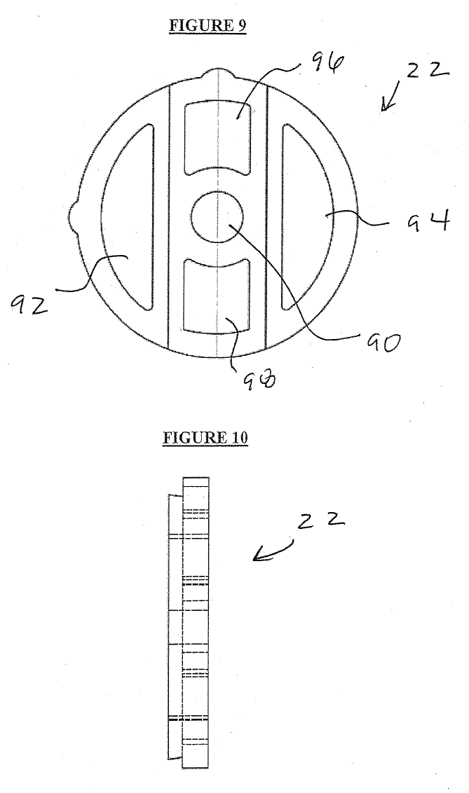

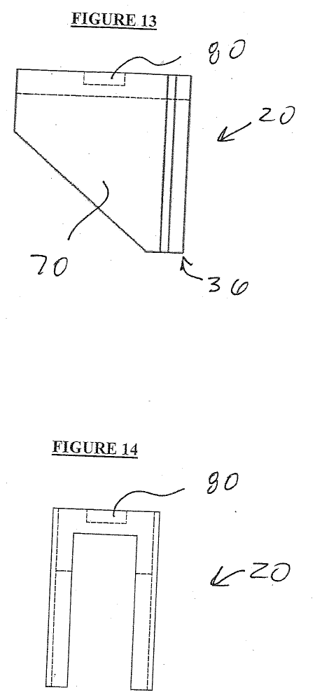

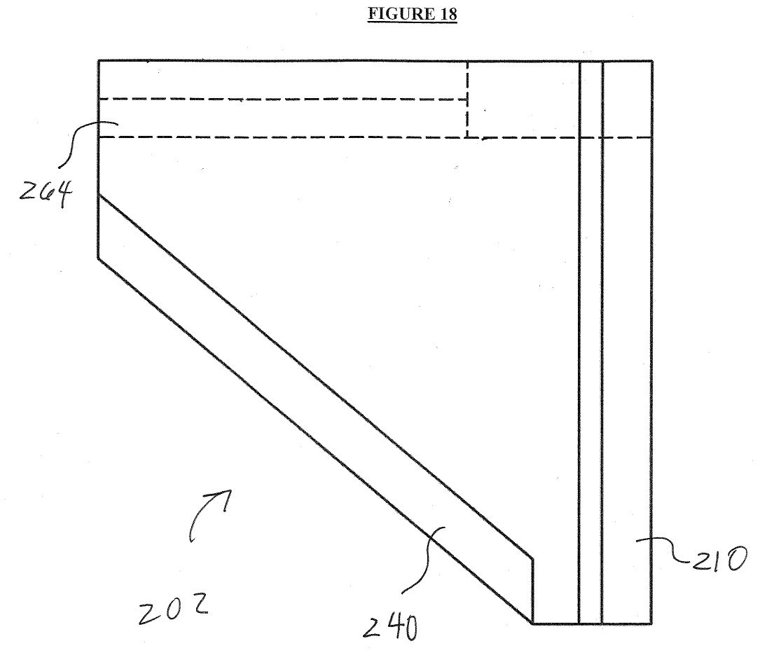

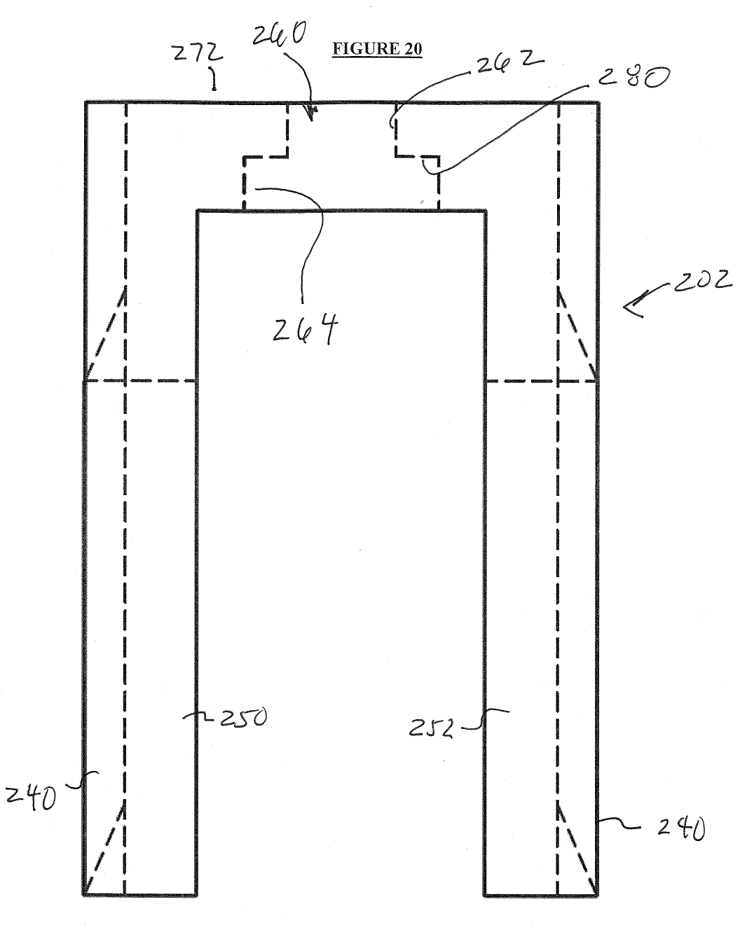

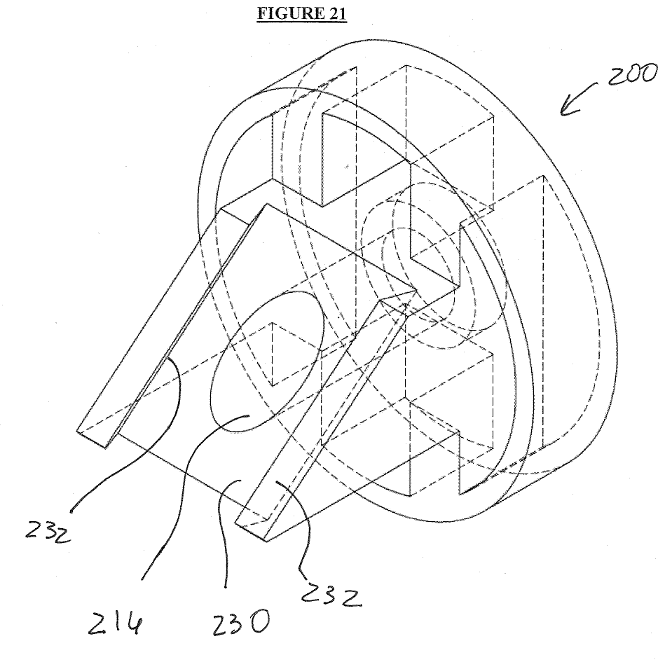

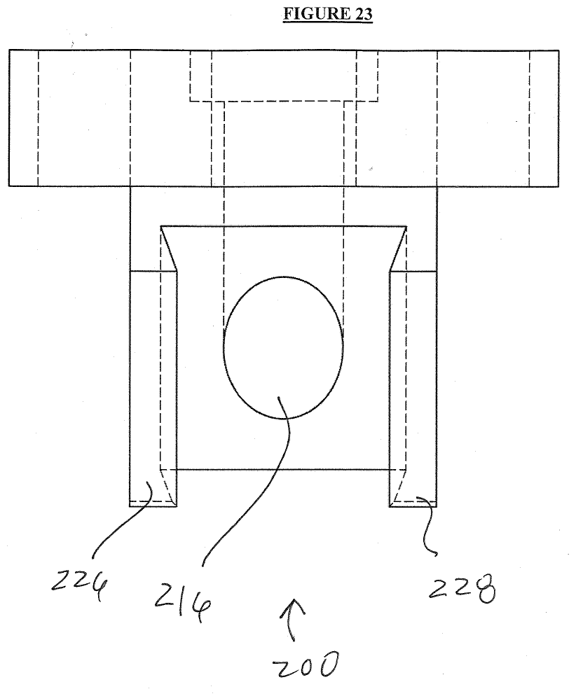

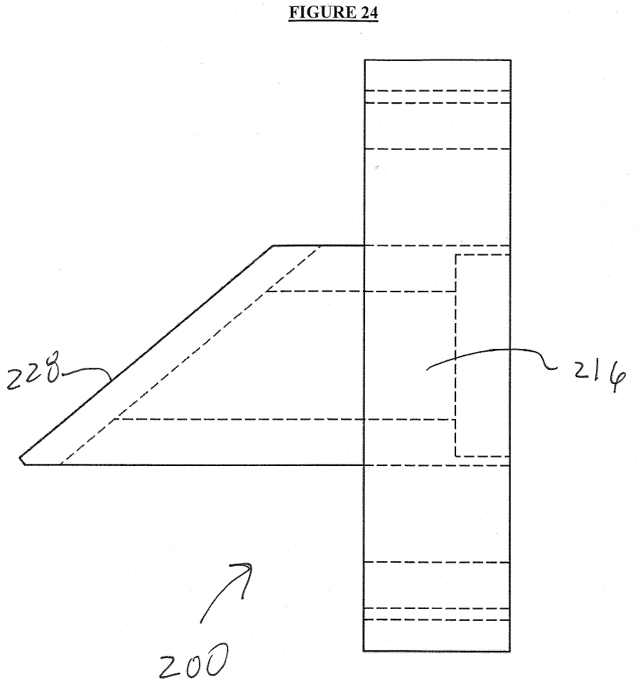

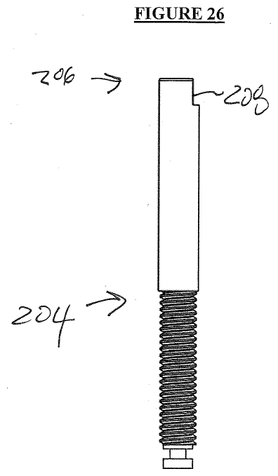

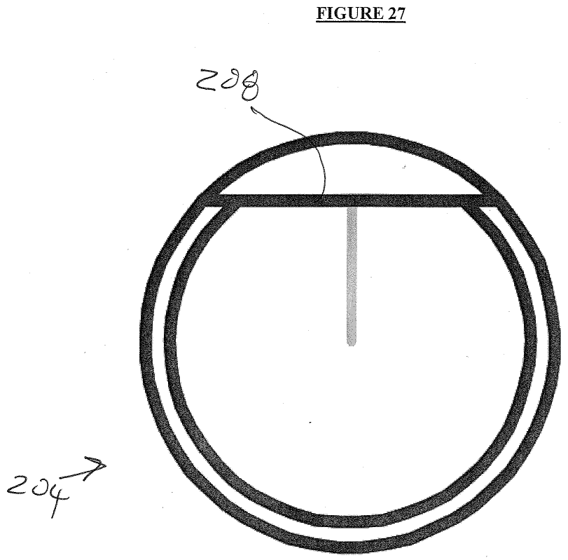

The preferred forms of the invention will now be described with reference to FIGS. 1-27. The appended claims are not limited to the preferred forms and no term and/or phrase used herein is to be given a meaning other than its ordinary meaning unless it is expressly stated otherwise.

A preferred form of the present invention is directed to a valve that prevent or reduces the flow of air to one or more elements in a fluid line. In a most preferred form, the valve prevents or reduces the flow of air to a water meter or similar device downstream of the valve to prevent or reduce air from being read as water by the water meter or similar device to prevent a water user from being overcharged for the actual water used by the water user.

The preferred forms described below include an inline adjustment feature that allows even an unskilled worker to readily, accurately and precisely adjust the force necessary to allow a fluid to pass through the valve. The preferred forms described below include a user-friendly adjustment tool that allows a user to adjust the force necessary to allow a fluid to pass through the valve between a plethora of force settings including a maximum force setting, a minimum force setting and numerous intermediate force settings without ever detaching the user-friendly adjustment tool from the valve.

The preferred forms described below include a locking member for locking the valve in a desired force setting.

The preferred forms described below include an anti-tampering member for preventing unauthorized individuals from tampering with the valve including but not limited to unauthorized adjustments of the force setting necessary to allow fluid to flow through the valve. Again, the foregoing describes preferred forms and no claim is limited to the preferred forms.

### FIGS. 1 Through 14

Referring to FIGS. 1 to 14, a valve A employing a preferred form of the invention is illustrated in one of many possible configurations. In the most preferred form, valve A is disposed in a water line supplying water to a building structure (e.g., an office building, a hotel, a home, a sports complex, etc.). In the most preferred form, valve A is disposed downstream of a water flow measuring device (e.g., a water meter) that determines the amount of water usage by the building structure. Valve A is specifically configured to significantly reduce or prevent air flow to the water flow measuring device to prevent an individual or entity from being billed for water usage that is actually air flowing through the water flow measuring device. Referring to FIG. 1, valve A includes a valve housing B having a fluid inlet 2 and a fluid outlet 4. In the most preferred form, inlet 2 is directly opposite of fluid outlet 4 (i.e., inlet 2 and outlet 4 are at opposing ends of housing B) so that water passes through housing B along a longitudinal axis of housing B.

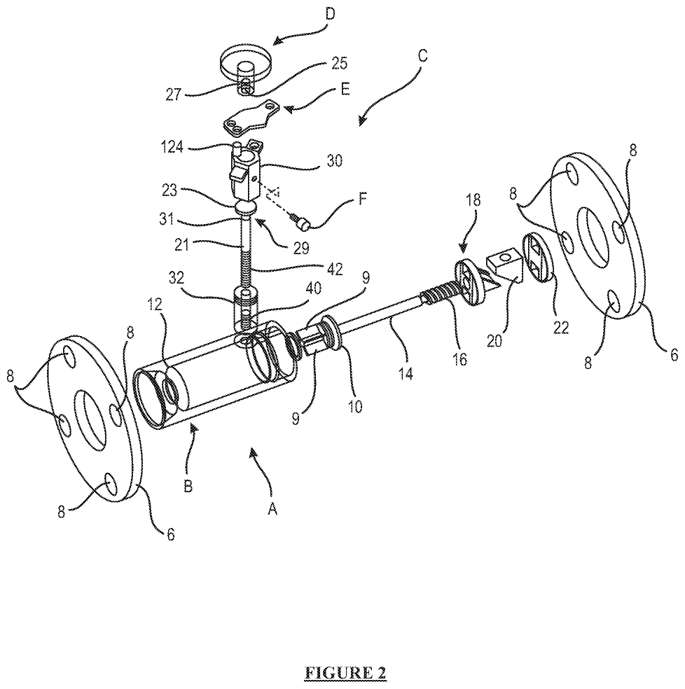

Referring to FIG. 2, mounting plates 6 having a plurality of bolt holes 8 can be permanently or otherwise fixed to housing B to detachably connect valve A and mounting plates 6 to complimentary members of the water line supplying water to the building structure downstream of one or more other components of the water line (e.g., a water meter). Valve A includes four alignment members 9, valve member 10, valve seat 12, spring support shaft 14, coil spring 16, spring support 18, cam 20 and anti-rotation member 22. While the preferred form includes a coil spring, any other suitable biasing member can be used.

Spring support shaft 14 is fixed to valve member 10 and alignment members 9 so that movement of valve member 10 causes corresponding movement of alignment members 9 and spring support shaft 14. Alignment members 9 ensure that valve member 10, shaft 14 and spring support 18 move in opposite directions on a predetermined path, e.g., a longitudinal axis of housing B. While four alignment members 9 uniformly spaced about shaft 14 are shown, the number, spacing and form of alignment members 9 may be readily varied as desired.

As shown in FIG. 1, when no force or an insufficient force to overcome the biasing force of spring 16 is applied to valve member 10, valve member 10 engages valve seat 12 to prevent the flow of fluid (water or air) through valve housing B. If a sufficient pressure is applied to valve member 10, alignment members 9, valve member 10 and shaft 14 will move to the right as seen in FIGS. 1 and 2. This movement will cause compression of spring 16 between valve member 10 and spring support 18. Preferably, spring support 18 cannot rotate about the longitudinal axis of housing B. As previously explained, alignment members 9 act to ensure that the above described movement of valve member 10 and shaft 14 is along the longitudinal axis of housing B.

Valve A includes an inline adjustment member C which allows for adjustment of the force applied by spring 16 to valve member 10 to vary the force required to allow fluid to flow through valve A. Adjustment member C includes a user-friendly handle D operably and detachably connected to shaft 21, a seal 23, an anti-tampering member E, a locking screw F, cam 20, anti-rotation member 22, upper adjustment housing portion 30 and lower adjustment housing portion 32. Seal 23 can be formed from any suitable material including an elastomeric material to seal inline adjustment member C thereby preventing fluid from flowing out an upper end of member C. Preferably, all other components of valve A are formed from metal (e.g., stainless steel) or any other suitable material.

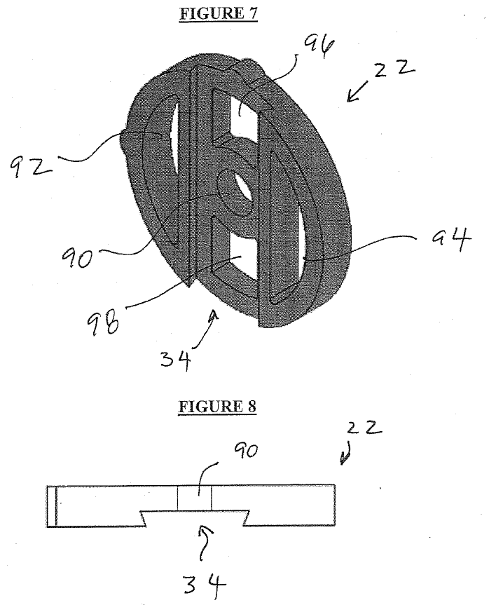

Anti-rotation member 22 is preferably fixed to housing B so that member 22 cannot move relative to housing B. As seen in, for example, FIG. 8, anti-rotation member 22 includes a tapered slot 34 to receive the tapered portion 36 of cam 20 (see FIG. 12) so that cam 20 can move inwardly and outwardly relative to the longitudinal axis of housing B (i.e., slide in tapered slot 34) but cam 20 cannot rotate about the longitudinal axis of housing B.

The detachable and operable connection between user-friendly handle D and shaft 21 may be accomplished by any suitable means. As seen in FIG. 2, handle D includes a non-circular internal bore portion 25 having a flat side 27 for receiving non-circular end portion 29 of shaft 21 having a complimentary flat side 31 so that the operable connection of handle D to shaft 21 may be accomplished by mounting handle D on the non-circular end portion 29 of shaft 21 so that end portion 29 extends into non-circular internal bore portion 25 and rotation of handle D causes shaft 21 to rotate. However, the operable connection between handle D and shaft 21 can be achieved in numerous other manners including a force fit. Alternatively, the user-friendly handle D may include a vertically and inwardly extending projection/tab formed in bore 25 that is received in a vertically extending slot formed in an exterior surface of shaft 21.

The detachable connection of handle D and shaft 21 is preferably configured such that handle D may be detached from shaft 21 merely by moving handle D in a direction away from shaft 21.

Lower adjustment housing portion 32 is connected to housing B in a fluid tight manner (e.g., welding or any other suitable fluid tight connection). Referring to FIG. 2, lower adjustment housing portion 32 includes internal threads 40 that are complimentary to external threads 42 on shaft 21. Further, adjustment housing portion 32 is detachably connected to adjustment housing portion 30 by preferably a threaded connection so adjustment housing portion 30 can be readily detached from adjustment housing portion 32. However, adjustment housing portion 32 can be fixed to adjustment housing portion 30.

To adjust the force necessary to open valve A to allow fluid flow therethrough, a user merely turns handle D clockwise or counter clockwise. Turning handle D causes shaft 21 to move inwardly or outwardly (i.e., towards or away from housing B) depending upon which way handle D is rotated. If handle D is rotated in a direction which causes shaft 21 to move inwardly (i.e., towards valve housing B), such movement will cause cam 20 to move inwardly and act on spring support 18 to cause spring support 18 to move to the left as seen in FIG. 2 and thereby compress spring 16 and increase the force necessary to open valve A.

If handle D is rotated in a direction which causes shaft 21 to move outwardly (i.e., away from valve housing B), such movement will cause cam 20 to move outwardly and act on spring support 18 to cause spring support 18 to move to the right as shown in FIG. 2 which in turn causes spring 16 to expand which decreases the force necessary to open valve A.

A locking screw F is provided to prevent adjustment/movement of shaft 21 once the desired force of valve A is set. Specifically, when an individual rotates screw F sufficiently in a first direction an inner terminal end of screw F will contact shaft 21 and prevent further movement of shaft 21. Locking screw F allows a user to readily and precisely set the force of spring 16 at a plethora of different incremental force settings.

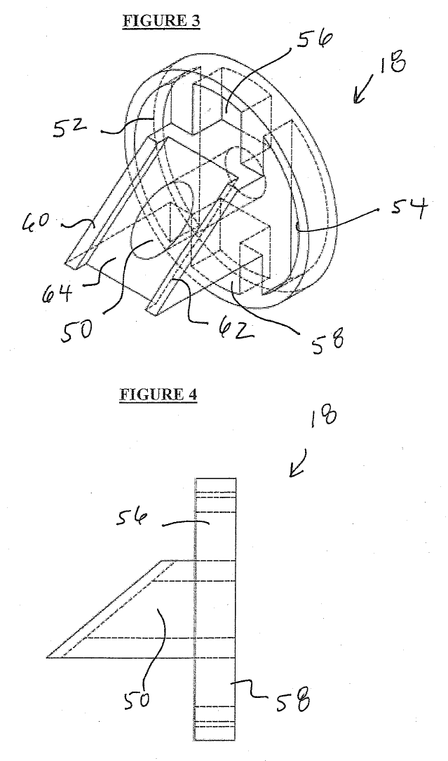

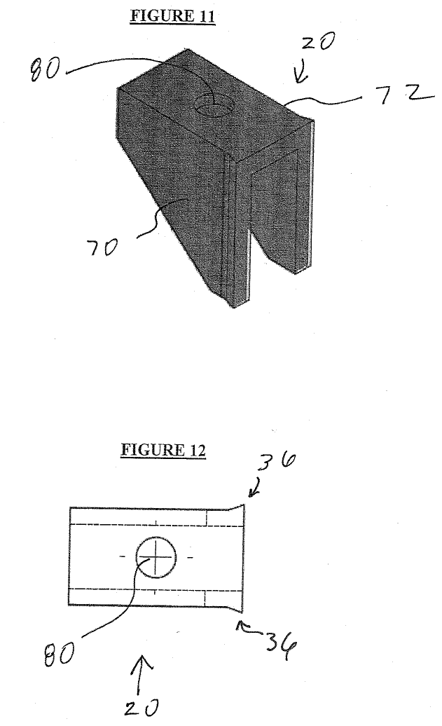

Referring to FIG. 3, spring support 18 includes a central opening 50 extending therethrough that allows shaft 14 to move relative to spring support member 18. Referring to FIG. 5, spring support 18 includes openings 52, 54, 56 and 58 configured to maximize the flow of fluid through spring support 18. Referring to FIG. 3, spring support 18 includes two raised and inclined walls 60 and 62 and an inclined surface 64. Referring to FIGS. 11 and 12, cam 20 includes tapered opposing sidewalls 70 and 72. Tapered opposing sidewalls 70 and 72 have a complimentary incline to that of inclined surface 64 of spring support 18.

During adjustment of valve A, the lowermost surface of opposing sidewalls 70 and 72 slide along inclined surface 64 of spring support 18. Raised and inclined walls 60 and 62 are spaced from each other a distance greater than the spacing between sidewalls 70 and 72 so that sidewalls 70 and 72 are guided by and slide between walls 60 and 62 of spring support 18. Cam 20 includes a circular depression 80 for receiving a lower terminal end of shaft 21. The spacing between sidewalls 70 and 72 is sufficient to allow spring support shaft 14 to move relative to and through cam 20.

Referring to FIGS. 7 to 10, anti-rotation member 22 further includes a central opening 90 for receiving shaft 14. Anti-rotation member 22 further includes openings 92, 94, 96 and 98 that preferably have the same shape and size of openings 52, 54, 56 and 58 respectively to maximize the flow of fluid through anti-rotation member 22.

Anti-tampering member E, as seen in FIG. 1, is pivotally connected to flange 110 of adjustment housing 30 by pin 112. To prevent tampering with valve A, handle D is detached from shaft 21 merely be raising handle D and anti-tampering member E is rotated so that opening 116 of anti-tampering member E is aligned with opening 118 formed in flange 120 of adjustment housing 30 to allow a user to put a lock through opening 116 and opening 118 to prevent an unauthorized user from accessing adjustment shaft 21 and thereby prevent any unauthorized alteration of the force setting of valve A. As shown in FIG. 2, anti-tampering member E may be provided with multiple openings for receiving the lock element. Further, a stop 124 may be provided to ensure that the anti-tampering member E can be readily set to a locking position.

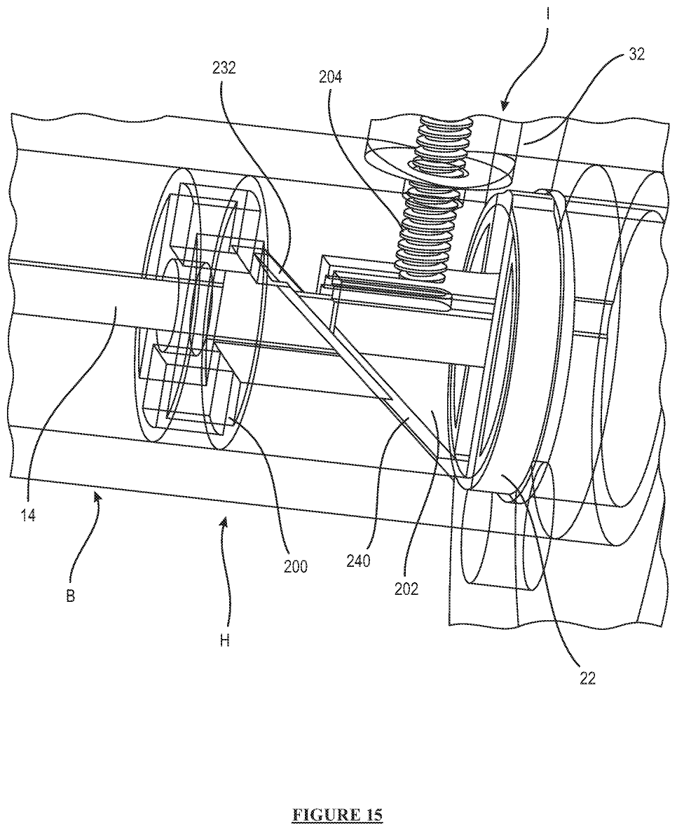

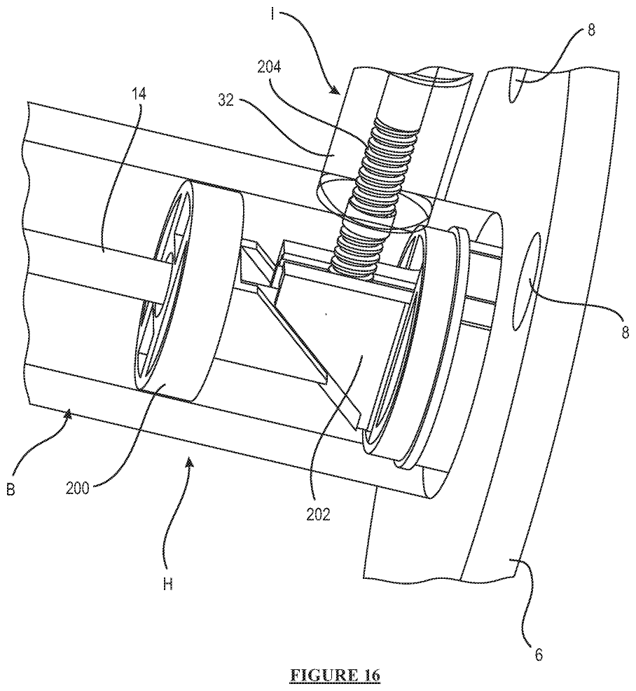

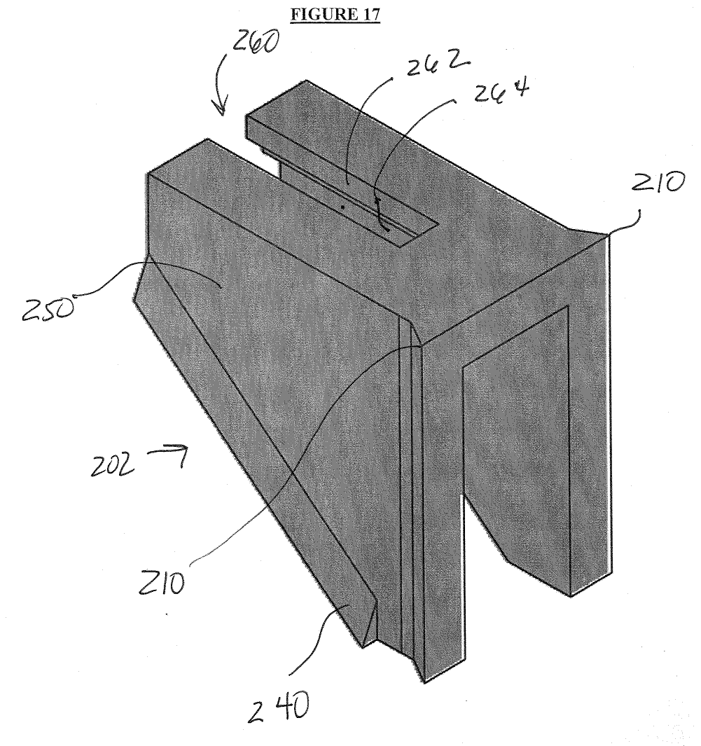

### FIGS. 15 Through 27

FIGS. 15 to 27 depict an alternative embodiment that is similar to the embodiment disclosed in FIGS. 1 to 14. Accordingly, only the differences will be described in detail. The same elements are given the same reference designations (i.e., reference numbers and reference letters). The only changes/alterations/modifications of the embodiment depicted in FIGS. 15 to 27 to the embodiment illustrated in FIGS. 1 to 14 are specific to cam member 20, spring support member 18 and shaft 21 of the embodiment illustrated in FIGS. 1 to 14.

Referring to FIGS. 15 to 27, a valve H employing another preferred form of the invention is illustrated in one of many possible configurations. In the most preferred form, valve H is disposed in a water line supplying water to a building structure (e.g., an office building, a hotel, a home, a sports complex, etc.). In the most preferred form, valve H is disposed downstream of a water flow measuring device (e.g., a water meter) that determines the amount of water usage by the building structure. Valve H is specifically configured to significantly reduce or prevent air flow to the water flow measuring device to prevent an individual or entity from being billed for water usage that is actually air flowing through the water flow measuring device. Referring to FIGS. 15 and 16, valve H includes a valve housing B having a fluid inlet and a fluid outlet as depicted in, for example, FIG. 2. In the most preferred form, the inlet is directly opposite of the fluid outlet (i.e., the inlet and the outlet are at opposing ends of housing B) so that water passes through housing B along a longitudinal axis of housing B.

Referring to FIGS. 2 and 16, mounting plates 6 having a plurality of bolt holes 8 can be permanently or otherwise fixed to housing B to detachably connect valve H and mounting plates 6 to complimentary members of the water line supplying water to the building structure downstream of one or more other components of the water line (e.g., a water meter). Valve H includes four alignment members that are the same as the four alignment members 9, a valve member that is the same as valve member 10, a valve seat that is the same as valve seat 12, a spring support shaft that is the same as spring support shaft 14, a coil spring that is the same as coil spring 16, a spring support 200, cam 202 and an anti-rotation member that is the same as anti-rotation member 22. While the preferred form includes a coil spring, any other suitable biasing member can be used.

Spring support shaft 14 is fixed to the valve member and the four alignment members so that movement of valve member causes corresponding movement of the four alignment members and spring support shaft 14. The alignment members ensure that the valve member, shaft 14 and spring support 200 move in opposite directions on a predetermined path, e.g., a longitudinal axis of housing B. While four alignment members uniformly spaced about shaft 14 are preferred, the number, spacing and form of alignment members may be readily varied as desired.

When no force or an insufficient force to overcome the biasing force of the spring is applied to the valve member, the valve member engages the valve seat to prevent the flow of fluid (water or air) through valve housing B. If a sufficient pressure is applied to the valve member, the alignment members, the valve member and shaft 14 will move to the right as seen in FIGS. 15 and 16. This movement will cause compression of the spring between the valve member and spring support 200. Preferably, spring support 200 cannot rotate about the longitudinal axis of housing B. As previously explained, the four alignment members act to ensure that the above described movement of the valve member and shaft 14 is along the longitudinal axis of housing B.

Valve H includes an inline adjustment member I which allows for adjustment of the force applied by the spring to the valve member to vary the force required to allow fluid to flow through valve H. Inline adjustment member I is the same as inline adjustment member C with the sole exception being that shaft 21 of inline adjustment member C is replaced by shaft 204. A user-friendly handle that is the same as user-friendly handle D is operably and detachably connected to shaft 204. The detachable and operable connection between the user-friendly handle and shaft 204 may be accomplished by any suitable means. The user-friendly handle includes a non-circular internal bore portion having a flat side for receiving non-circular end portion 206 of shaft 204 having a complimentary flat side 208 so that the operable connection of the handle to shaft 204 may be accomplished by mounting the handle on the non-circular end portion 206 of shaft 204 so that end portion 206 extends into the non-circular internal bore portion of the handle and rotation of the handle causes shaft 204 to rotate. However, the operable connection between the handle and shaft 204 can be achieved in numerous other manners including a force fit. Alternatively, the user-friendly handle may include a vertically and inwardly extending projection/tab formed in the internal bore that is received in a vertically extending slot formed in an exterior surface of shaft 204.

The detachable connection of the handle and shaft 204 is preferably configured such that the handle may be detached from shaft 204 merely by moving the handle in a direction away from shaft 204.

The inline adjustment member I includes a seal that is the same as seal 23, an anti-tampering member that is the same as anti-tampering member E, a locking screw that is the same as locking screw F, cam 202, an anti-rotation member that is the same as anti-rotation member 22, an upper adjustment housing portion that is the same as upper adjustment housing portion 30 and a lower adjustment housing portion that is the same as lower adjustment housing portion 32. The seal can be formed from any suitable material including an elastomeric material to seal inline adjustment member I thereby preventing fluid from flowing out an upper end of member I. Preferably, all other components of valve H are formed from metal (e.g., stainless steel) or any other suitable material.

Anti-rotation member 22 is preferably fixed to housing B so that member 22 cannot move relative to housing B. Anti-rotation member 22 includes tapered slot 34 to receive the tapered portions 210 of cam 202 (see, for example, FIG. 17) so that cam 202 can move inwardly and outwardly relative to the longitudinal axis of housing B (i.e., slide in tapered slot 34) but cam 202 cannot rotate about the longitudinal axis of housing B.

Lower adjustment housing portion 32 is connected to housing B in a fluid tight manner (e.g., welding or any other suitable fluid tight connection). Referring to FIGS. 2, 15, 16, 25 and 26, lower adjustment housing portion 32 includes internal threads 40 that are complimentary to external threads on shaft 204. Further, lower adjustment housing portion 32 is detachably connected to upper adjustment housing portion by preferably a threaded connection so upper adjustment housing portion can be readily detached from lower adjustment housing portion 32. However, adjustment housing portion 32 can be fixed to the upper adjustment housing portion.

To adjust the force necessary to open valve H to allow fluid flow therethrough, a user merely turns the user-friendly handle clockwise or counter clockwise. Turning the user-friendly handle causes shaft 204 to move inwardly or outwardly (i.e., towards or away from housing B) depending upon which way the user-friendly handle is rotated. If the handle is rotated in a direction which causes shaft 204 to move inwardly (i.e., towards valve housing B), such movement will cause cam 202 to move inwardly and act on spring support 200 to cause spring support 200 to move to the left as seen in, for example, FIG. 15 and thereby compress the spring mounted on and about shaft 14 and increase the force necessary to open valve I.

If the handle is rotated in a direction which causes shaft 204 to move outwardly (i.e., away from valve housing B), such movement will cause cam 202 to move outwardly and act on spring support 200 to cause spring support 200 to move to the right as shown in, for example, FIG. 15 which in turn causes the spring to expand which decreases the force necessary to open valve I.

A locking screw that is the same as locking screw F is provided to prevent adjustment/movement of shaft 204 once the desired force of valve I is set. Specifically, when an individual rotates the locking screw sufficiently in a first direction an inner terminal end of the screw will contact shaft 204 and prevent further movement of shaft 204. The locking screw allows a user to readily and precisely set the force of the spring at a plethora of different incremental force settings.

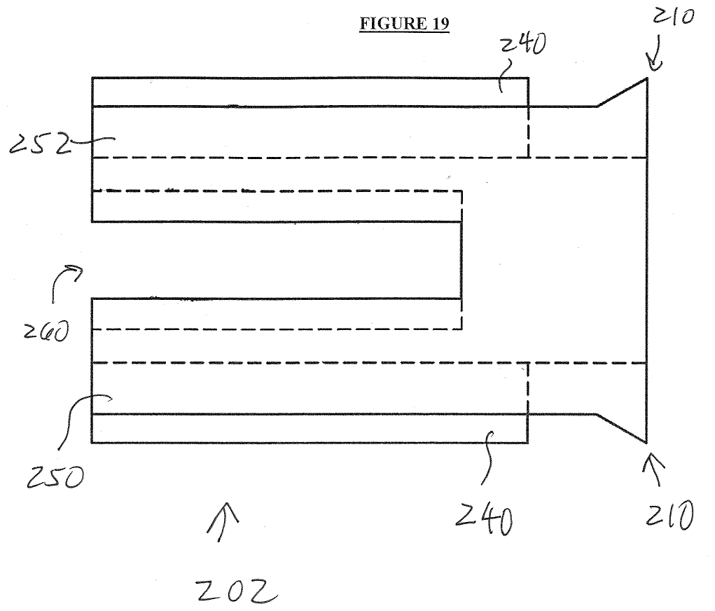

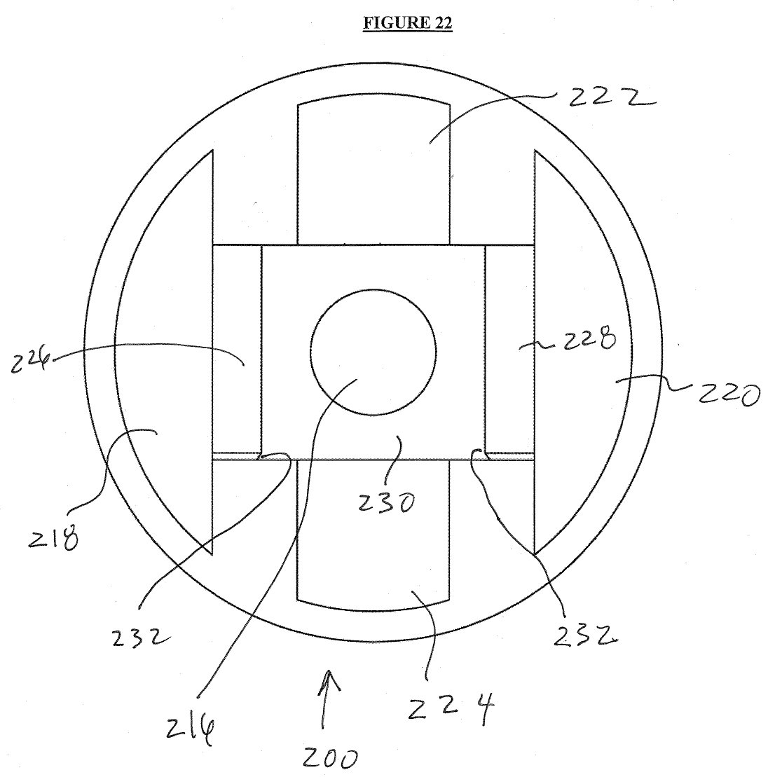

Referring to FIGS. 15, 16 and 21 to 24, spring support 200 includes a central opening 216 extending therethrough that allows shaft 14 to move relative to spring support member 200. Referring to FIG. 22, spring support 200 includes openings 218, 220, 222 and 224 configured to maximize the flow of fluid through spring support 200. Referring to FIGS. 17 to 24, spring support 200 includes two raised and inclined walls 226 and 228 and an inclined surface 230 extending between walls 226 and 228. Inclined walls 226 and 228 each include an inwardly inclined inner surface 232 that forms a tapered inner recess that receives a corresponding tapered portion 240 (see, for example, FIG. 19) of cam 202.

Referring to FIGS. 17 to 20, cam 202 includes tapered opposing sidewalls 250 and 252. Tapered opposing sidewalls 250 and 252 have a complimentary incline to that of inclined surface 230 of spring support 200. The spacing between sidewalls 250 and 252 is sufficient to allow spring support shaft 14 to move relative to and through cam 202.

During adjustment of valve I, the lowermost surface of opposing sidewalls 250 and 252 slide along inclined surface 230 of spring support 200 and tapered portions 240 of cam 202 slide in the corresponding tapered inner recess formed by inwardly inclined inner surface 232 of walls 226 and 228 of support 200. This configuration permits cam 202 to slide relative to spring support 200 but prevents detachment of cam 202 from the sliding connection with spring support 200.

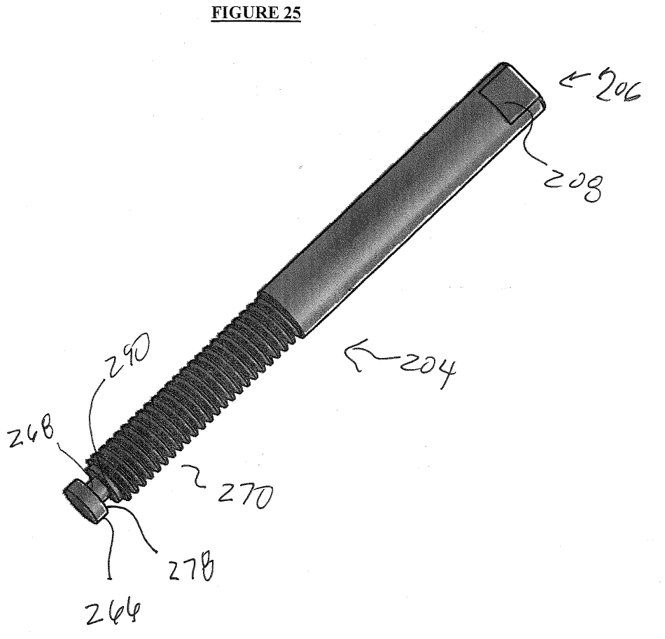

Referring to FIGS. 17 to 20, cam 202 includes a T-shaped slot 260 including an upper slot segment 262 and a lower slot segment 264. The width of lower slot segment 264 is sized to be slightly larger than the diameter of inner end portion 266 of shaft 204 (see, for example, FIG. 25) so that the inner end portion 266 can slide into lower slot segment 264. The width of upper slot segment 262 is sized to be slightly larger than the diameter of portion 268 of shaft 204 so that segment 262 can receive portion 268 of shaft 204. The upper slot segment 262 is sized to be smaller than the diameter of end portion 266 of shaft 204 to prevent detachment of shaft 204 from cam 202 when valve I is fully assembled and installed in an operating position. Threaded section 270 of shaft 204 has a diameter greater than the width of segment 262 so that a lowermost surface of threaded section 270 contacts an upper surface 272 of cam 202. The above described configuration of the T-shaped slot 260 of cam 202 and shaft 204 prevents shaft 204 from being detached from cam 202 regardless of the direction and number of rotations of the user-friendly handle of the inline adjustment member I. Further, the above described configuration of the T-shaped sot 260 of cam 202 and shaft 204 allows for an upward pulling force to be exerted on cam 202 by an uppermost surface 278 of portion 266 of shaft 204 contacting surface 280 of slot 260. More specifically, when the user-friendly handle is rotated in a direction which causes shaft 204 to move outwardly and away from the longitudinal axis of housing B, uppermost surface 278 contacts surface 280 of cam 202 and acts to pull cam 202 upwardly and away from the longitudinal axis of housing B causing the spring to expand and move support 200 to the right as seen in FIGS. 15 and 16. When the user-friendly handle is rotated in a direction which causes shaft 204 to move inwardly and toward the longitudinal axis of housing B, the lowermost surface 290 of threaded section 270 contacts surface 272 of cam 202 and acts to push cam 202 inwardly and towards the longitudinal axis of housing B causing support 200 to the left, as seen in FIGS. 15 and 16, thereby compressing the spring. The above described configuration of shaft 204 and cam 202 also allows for precise and accurate adjustment of the force of the spring.

Anti-rotation member 22 further includes a central opening for receiving shaft 14. Anti-rotation member 22 further includes four openings that preferably have the same shape and size as the corresponding one of openings 218, 220, 224 and 226 to maximize the flow of fluid through anti-rotation member 22.

Inline adjustment member I has an anti-tampering member that is the same as anti-tampering member E, to prevent tampering with valve I. It will be readily recognized from the above description, that valve A could be readily converted to valve I by merely replacing support 18, cam 20 and shaft 21 with support 200, cam 202 and shaft 204.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

I claim:

1. An apparatus for reducing airflow to one or more members in a water line, said apparatus comprising:
a) a valve configured to be installed in the water line, said valve being configured to prevent or reduce air flow to one or more members in the water line, said valve including a valve housing having first and second opposing ends, said first opposing end having a fluid inlet and said second opposing end having a fluid outlet, said valve further including a valve member, a valve seat and a spring, said spring being configured to exert a biasing force on said valve member to cause said valve member to engage said valve seat to prevent fluid from flowing through said valve housing; and,
b) a spring force adjustment member operably connected to said valve, said spring force adjustment member being configured to permit a user to adjust the force of said spring without removing the valve from the water line, said spring force adjustment member having a user manipulated member connected to said valve, said user manipulated member when connected to said valve being configured to allow a user to adjust the force of the spring without detaching said user manipulated member from said valve in at least one of the following manners: (i) from a minimum spring force to a maximum spring force; and, (ii) from a maximum spring force to a minimum spring force.

2. An apparatus as recited in claim 1, wherein:
(a) said user manipulated member is disposed outside of said valve housing.

3. An apparatus as recited in claim 1, wherein:
(a) said user manipulated member is a detachable handle detachably connected to said valve.

4. An apparatus as recited in claim 3, wherein:
(a) said detachable handle when connected to said valve is configured to allow a user to adjust the force of the spring without detaching said detachable handle from said valve in both of the following manners: (i) from a minimum spring force to a maximum spring force; and, (ii) from a maximum spring force to a minimum spring force.

5. An apparatus as recited in claim 4, wherein:
(a) said detachable handle when connected to said valve is configured to allow a user to adjust the force of the spring without detaching said detachable handle from said valve to a plurality of intermediate spring forces between the maximum spring force and the minimum spring force wherein each of said plurality of intermediate spring forces is a different spring force.

6. An apparatus as recited in claim 1, wherein:
(a) said spring force adjustment member includes a moveable shaft having a longitudinal axis, said moveable shaft is connected to a first cam, said moveable shaft is configured to move in two opposing directions along the longitudinal axis of said moveable shaft to cause corresponding movement of the first cam wherein the two opposing directions include a first direction which is away from the first cam and a second direction which is towards the first cam.

7. An apparatus as recited in claim 1, wherein:
(a) said spring force adjustment member includes a first cam moveable between a first position in which the spring exerts a minimum spring force and a second position in which the spring exerts a maximum spring force, said spring force adjustment member further includes an anti-rotation member operably connected to said first cam to prevent said first cam from rotating about a longitudinal axis of said valve housing while permitting said first cam to move between said first position and said second position.

8. An apparatus as recited in claim 7, wherein:
(a) said anti-rotation member is positioned in said valve housing between said fluid inlet and said fluid outlet and includes a plurality of openings for allowing a fluid to pass through said anti-rotation member.

9. An apparatus as recited in claim 8, wherein:
(a) said anti-rotation member includes a tapered slot for receiving a complimentary shaped portion of said first cam to allow said first cam to move between said first position and said second position while preventing said first cam from rotating about the longitudinal axis of said valve housing.

10. An apparatus for reducing airflow to one or more members in a water line, said apparatus comprising:
a) a valve configured to be installed in the water line, said valve being configured to prevent or reduce air flow to one or more members in the water line, said valve including a valve housing having first and second opposing ends, said first opposing end having a fluid inlet and said second opposing end having a fluid outlet, said valve further including a valve member, a valve seat and a biasing member being configured to exert a biasing force on said valve member to cause said valve member to engage said valve seat to prevent fluid from flowing through said valve housing; and,
b) a biasing force adjustment member operably connected to said valve, said biasing force adjustment member being configured to permit a user to adjust the force of said biasing member without removing the valve from the water line, said biasing force adjustment member including an activation shaft and a first cam, said activation shaft being operably connected to said first cam, said activation shaft having a longitudinal axis, said activation shaft being configured to move in two opposing directions along the longitudinal axis of said activation shaft to cause corresponding movement of the first cam wherein the two opposing directions include a first direction which is away from the first cam and a second direction which is towards the first cam.

11. An apparatus as recited in claim 10, wherein:
(a) said biasing member is a spring and said valve further includes a spring support for supporting one end of said spring, said spring extends between said spring support and said valve member, said spring support has a plurality of openings for allowing a fluid to pass through said spring support; and,
(b) said spring support has a first portion, said first portion has a complimentary shape to that of said first cam so that said first cam and said first portion act together to adjust the force of said spring.

12. An apparatus as recited in claim 11, wherein:
(a) said valve further includes a spring support shaft for supporting said spring, said spring support having an opening extending through said first portion to allow said spring support shaft to move relative to said first portion of said spring support.

13. An apparatus as recited in claim 12, wherein:
(a) said biasing force adjustment member further includes an anti-rotation member operably connected to said first cam to prevent said first cam from rotating about a longitudinal axis of said valve housing while permitting said first cam to move between a first position in which said spring exerts a minimum spring force and a second position in which said spring exerts a maximum spring force.

14. An apparatus as recited in claim 13, wherein:
(a) said anti-rotation member includes a tapered slot for receiving a complimentary shaped portion of said first cam to allow said first cam to move between said first position and said second position while preventing said first cam from rotating about the longitudinal axis of said valve housing.

15. An apparatus for reducing airflow to one or more members in a water line, said apparatus comprising:
a) a valve configured to be installed in the water line, said valve being configured to prevent or reduce air flow to one or more members in the water line, said valve including a valve housing having first and second opposing ends, said first opposing end having a fluid inlet and said second opposing end having a fluid outlet, said valve further including a valve member, a valve seat and a spring being configured to exert a biasing force on said valve member to cause said valve member to engage said valve seat to prevent fluid from flowing through said valve housing; and,
b) a spring force adjustment member operably connected to said valve, said spring force adjustment member being configured to permit a user to adjust the force of said spring without removing the valve from the water line; and,
c) an anti-tampering member operably associated with said spring force adjustment member for preventing an unauthorized individual from accessing said spring force adjustment member to adjust the spring force of said spring.

16. An apparatus as recited in claim 15, wherein:
(a) said spring force adjustment member includes an activation shaft and a first cam, said activation shaft is operably connected to said first cam, said activation shaft has a longitudinal axis, said activation shaft is configured to move in two opposing directions along the longitudinal axis of said activation shaft to cause corresponding movement of the first cam wherein the two opposing directions include a first direction which is away from the first cam and a second direction which is towards the first cam.

17. An apparatus as recited in claim 16, wherein:
(a) said force adjustment member further includes an anti-rotation member operably connected to said first cam to prevent said first cam from rotating about a longitudinal axis of said valve housing while permitting said first cam to move between a first position and a second position.

18. An apparatus as recited in claim 17, wherein:
(a) said anti-rotation member includes a plurality of openings for permitting a fluid to pass therethrough.

19. An apparatus as recited in claim 18, wherein:
(a) said valve further includes a spring support for supporting one end of said spring, said spring extends between said spring support and said valve member, said spring support has a plurality of openings for allowing a fluid to pass through said spring support; and,
(b) said spring support has a first portion, said first portion has a complimentary shape to that of said first cam so that said first cam and said first portion act together to adjust the force of said spring.

20. An apparatus as recited in claim 19, wherein:
(a) said spring support and said anti-rotation member each have an opening for receiving a spring support shaft supporting said spring; and,
(b) said first cam has a cavity for receiving said spring support shaft so that said spring support shaft can slide in said cavity of said first cam.
